(19) United States
(12) Patent Application Publication
(10) Pub. No.: US 2022/0230640 A1
(43) Pub. Date: Jul. 21, 2022

(54) APPARATUS FOR ADAPTIVE CONVERSATION

(71) Applicant: KOREA ELECTRONICS TECHNOLOGY INSTITUTE, Seongnam-si (KR)

(72) Inventors: Jin Yea JANG, Suwon-si (KR); Min Young JUNG, Hwaseong-si (KR); San KIM, Seongnam-si (KR); Sa Im SHIN, Seoul (KR)

(21) Appl. No.: 17/716,445

(22) Filed: Apr. 8, 2022

Related U.S. Application Data
(63) Continuation of application No. PCT/KR2020/012415, filed on Sep. 15, 2020.

(30) Foreign Application Priority Data
Oct. 10, 2019 (KR) 10-2019-0125446

(51) Int. Cl. G10L 15/22; G10L 15/30

(52) U.S. Cl. CPC G10L 15/22; G10L 2015/223; G10L 15/30

(57) ABSTRACT

This application relates to an apparatus for adaptive conversation. In one aspect, the apparatus includes a server communication circuit that forms a communication channel with a user terminal and a server processor functionally connected to the server communication circuit. The server processor may receive, from the user terminal, a user utterance and surrounding external information acquired at a point in time at which the user utterance is collected. The server processor may also generate one word input by combining the surrounding external information with input information generated by performing natural language processing on the user utterance. The server processor may further generate a response sentence by applying the word input to a neural network model, and transmit the response sentence to the user terminal.

### CROSS REFERENCE TO RELATED APPLICATIONS

This is a continuation application of International Patent Application No. PCT/KR2020/012415, filed on Sep. 15, 2020, which claims priority to Korean patent application No. 10-2019-0125446 filed on Oct. 10, 2019, contents of both of which are incorporated herein by reference in their entireties.

### BACKGROUND

### Technical Field

The present disclosure relates to an adaptive conversation function and, more particularly, to an adaptive conversation apparatus capable of providing a response corresponding to a user utterance based on external information and contents of the user utterance.

### Description of Related Technology

As electronic devices have developed into portable types, a variety of functions to provide information are supported. Nowadays, users can easily search for and obtain necessary information regardless of place or time. Such a portable electronic device is developing into a conversation system capable of understanding a user's question and providing a corresponding response, beyond a function of simply searching for and displaying information.

### SUMMARY

One aspect of the present disclosure is an apparatus for an adaptive conversation that can provide a more natural and meaningful conversation function by collecting external information of a user conducting a conversation and by generating a response tailored to a user's situation based on the collected external information.

Another aspect of the present disclosure is an apparatus for an adaptive conversation that can provide an adaptive response relying on configuration of external information even for the same user utterance input and, based on neural network learning, minimize the effort for designing additional rules to utilize external information.

According to an embodiment of the present disclosure, a conversation support server device includes a server communication circuit establishing a communication channel with a user terminal and a server processor functionally connected to the server communication circuit. The server processor may be configured to receive, from the user terminal, a user utterance and surrounding external information acquired at a time of collecting the user utterance, to generate one word input by combining input information generated by performing natural language processing on the user utterance with the surrounding external information, to generate a response sentence by applying the word input to a neural network model, and to transmit the response sentence to the user terminal.

The server processor may produce formalized information corresponding to the surrounding external information, and then generate the one word input by combining the formalized information with the input information.

In addition, the server processor may receive location information of the user terminal as the surrounding external information, and detect a place name or place characteristic information corresponding to the location information mapped to map information.

In addition, the server processor may receive sensing information of a sensor included in the user terminal as the surrounding external information, and produce formalized information corresponding to the sensing information.

According to an embodiment of the present disclosure, a user terminal includes a communication circuit establishing a communication channel with a conversation support server device, a sensor collecting sensing information, a microphone collecting user utterances, an output unit outputting response information received from the conversation support server device, and a processor operatively connected to the communication circuit, the sensor, the microphone, and the output unit. The processor may be configured to collect the sensing information as surrounding external information by using the sensor while collecting the user utterances through the microphone, to transmit the user utterances and the surrounding external information to the conversation support server device, to receive, from the conversation support server device, a response sentence generated by applying input information obtained through natural language processing of the user utterances and information obtained by formalizing the surrounding external information to a neural network model, and to output the received response sentence to the output unit.

The processor may be configured to collect at least one of external temperature, external illuminance, current location, and current time as the surrounding external information, and transmit the collected surrounding external information to the conversation support server device.

According to the present disclosure, an apparatus for adaptive conversation can provide a conversation interface function of a conversational artificial intelligence assistant system by providing a conversation suitable for a user's utterance and situation.

In addition, the present disclosure can improve user satisfaction by providing a natural conversation suitable for a conversation partner's situation, and implement an adaptive conversation system more simply while efficiently managing resources by utilizing external information.

### BRIEF DESCRIPTION OF THE DRAWINGS

FIG. 1 is a diagram illustrating an exemplary configuration of an adaptive conversation system according to an embodiment of the present disclosure.

FIG. 2 is a diagram illustrating an exemplary configuration of a conversation support server device in the configuration of an adaptive conversation system according to an embodiment of the present disclosure.

FIG. 3 is a diagram illustrating an exemplary configuration of a user terminal in the configuration of an adaptive conversation system according to an embodiment of the present disclosure.

FIG. 4 is a diagram illustrating an exemplary operating method of a user terminal in an operating method of an adaptive conversation system according to an embodiment of the present disclosure.

FIG. 5 is a diagram illustrating an exemplary operating method of a conversation support server device in an operating method of an adaptive conversation system according to an embodiment of the present disclosure.

### DETAILED DESCRIPTION

The current conversation system generally provides a conversation based on a predetermined rule rather than offering a natural conversation or, even if it is not rule-based, generates and provides the same answer to the user's same question. This makes the user feel awkward in the conversation or does not provide the user with an appropriate conversation, so it is difficult to give great satisfaction.

In the following description, only parts necessary to understand embodiments of the present disclosure will be described, and other parts will not be described to avoid obscuring the subject matter of the present disclosure.

Terms used herein should not be construed as being limited to their usual or dictionary meanings. In view of the fact that the inventor can appropriately define the meanings of terms in order to describe his/her own invention in the best way, the terms should be interpreted as meanings consistent with the technical idea of the present disclosure. In addition, the following description and corresponding drawings merely relate to specific embodiments of the present disclosure and do not represent all the subject matter of the present disclosure. Therefore, it will be understood that there are various equivalents and modifications of the disclosed embodiments at the time of the present application.

Now, embodiments of the present disclosure will be described in detail with reference to the accompanying drawings.

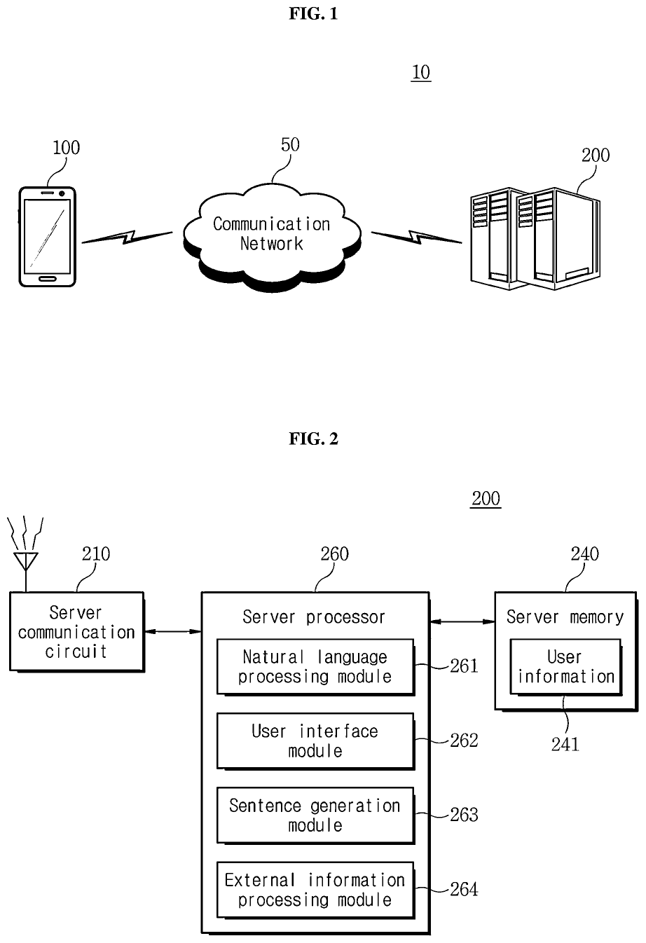

FIG. 1 is a diagram illustrating an exemplary configuration of an adaptive conversation system according to an embodiment of the present disclosure.

Referring to FIG. 1, an adaptive conversation system 10 according to an embodiment of the present disclosure may include a user terminal 100, a communication network 50, and a conversation support server device 200.

The communication network 50 may establish a communication channel between the user terminal 100 and the conversation support server device 200. The communication network 50 may have various forms. For example, the communication network 50 collectively refers to a closed network such as a local area network (LAN) or a wide area network (WAN), an open network such as the Internet, a network based on code division multiple access (CDMA), wideband CDMA (WCDMA), global system for mobile communications (GSM), long term evolution (LTE), or evolved packet core (EPC), next-generation networks to be implemented in the future, and computing networks. In addition, the communication network 50 of the present disclosure may be configured to include, for example, a plurality of access networks (not shown), a core network (not shown), and an external network such as the Internet (not shown). The access network (not shown) performs wired/wireless communication through a mobile communication terminal device and may be implemented with, for example, a plurality of base stations and a base station controller. The base station (BS) may include a base transceiver station (BTS), a NodeB, an eNodeB, etc., and the base station controller (BSC) may include a radio network controller (RNC) or the like. In addition, a digital signal processing unit and a radio signal processing unit, which are integrally implemented in the base station, may be separately implemented as a digital unit (DU) and a radio unit (RU), respectively. A plurality of RUs (not shown) may be installed in a plurality of areas, respectively, and connected to a centralized DU (not shown).

In addition, the core network (not shown) constituting the mobile network together with the access network (not shown) connects the access network (not shown) and an external network, for example, the Internet (not shown). The core network (not shown), which is a network system performing main functions for a mobile communication service such as mobility control and switching between access networks (not shown), performs circuit switching or packet switching and manages and controls a packet flow in the mobile network. In addition, the core network (not shown) manages inter-frequency mobility, controls traffic in the access network (not shown) and the core network (not shown), and performs a function of interworking with other networks, for example, the Internet (not shown). The core network (not shown) may be configured to further include a serving gateway (SGW), a PDN gateway (PGW), a mobile switching center (MSC), a home location register (HLR), a mobile mobility entity (MME), and a home subscriber server (HSS). In addition, the Internet (not shown), which is a public network for exchanging information in accordance with TCP/IP protocol, is connected to the user terminal 100 and the conversation support server device 200, and is capable of transmitting information provided from the conversation support server device 200 to the user terminal 100 through the core network (not shown) and the access network (not shown). Also, the Internet is capable of transmitting various kinds of information received from the user terminal device 100 to the conversation support server device 200 through the access network (not shown) and the core network (not shown).

The user terminal 100 may be connected to the conversation support server device 200 through the communication network 50. The user terminal 100 according to an embodiment of the present disclosure may be in general a mobile communication terminal device, which may include a network device capable of accessing the communication network 50 provided in the present disclosure and then transmitting and receiving various data. The user terminal 100 may also be referred to as a terminal, a user equipment (UE), a mobile station (MS), a mobile subscriber station (MSS), a subscriber station (SS), an advanced mobile station (AMS), a wireless terminal (WT), a device-to-device (D2D) device, or the like. However, the user terminal 100 of the present disclosure is not limited to the above terms, and any apparatus connected to the communication network 50 and capable of transmitting/receiving data may be used as the user terminal 100 of the present disclosure. The user terminal 100 may perform voice or data communication through the communication network 50. In this regard, the user terminal 100 may include a memory for storing a browser, a program, and a protocol, and a processor for executing, operating, and controlling various programs. The user terminal 100 may be implemented in various forms and may include a mobile terminal to which a wireless communication technology is applied, such as a smart phone, a tablet PC, a PDA, or a potable multimedia player (PMP). In particular, the user terminal 100 of the present disclosure is capable of transmitting user utterance information and external information to the conversation support server device 200 through the communication network 50 and also receiving response information corresponding to the user utterance information and external information from the conversation support server device 200.

The conversation support server device 200 provides and manages a conversation function application installed in the user terminal 100. The conversation support server device 200 may be a web application server (WAS), Internet information server (IIS), or a well-known web server using Apache Tomcat or Nginx on the Internet. In addition, one of devices constituting the network computing environment may be the conversation support server device 200 according to an embodiment of the present disclosure. In addition, the conversation support server device 200 may support an operating system (OS) such as Linux or Windows and execute received control commands. In terms of software, program modules implemented through a language such as C, C++, Java, Visual Basic, or Visual C may be included. In particular, the conversation support server device 200 according to an embodiment of the present disclosure may install a conversation function application in the user terminal 100, establish a communication channel with the user terminal 100 under user's control, and provide, upon receiving user utterance information and external information from the user terminal 100, corresponding response information to the user terminal 100.

As described above, in the adaptive conversation system 10 according to an embodiment of the present disclosure, the user terminal 100 and the conversation support server device 200 establish a communication channel therebetween through the communication network 50, and when the conversation function application related to the use of the adaptive conversation function is installed and executed in the user terminal 100, the conversation support server device 200 generates response information based on user utterance information and external information received from the user terminal 100 and provides the response information to the user terminal 100. As such, the adaptive conversation system 10 of the present disclosure generates the response information based on the external information around the user who owns the user terminal 100 as well as the user utterance information, and thereby provides the response information more suitable for the user's situation. This may increase the user's satisfaction with the conversation function and also improve the reliability of providing information needed to the user.

FIG. 2 is a diagram illustrating an exemplary configuration of a conversation support server device in the configuration of an adaptive conversation system according to an embodiment of the present disclosure.

Referring to FIG. 2, the conversation support server device 200 may include a server communication circuit 210, a server memory 240, and a server processor 260.

The server communication circuit 210 may establish a communication channel of the conversation support server device 200. The server communication circuit 210 may establish a communication channel with the user terminal 100 in response to a request for execution of a user conversation function. The server communication circuit 210 may receive user utterance information and external information from the user terminal 100 and provide them to the server processor 260. The server communication circuit 210 may transmit response information corresponding to the user utterance information and the external information to the user terminal 100 under the control of the server processor 260.

The server memory 240 may store various data or application programs related to the operation of the conversation support server device 200. In particular, the server memory 240 may store a program related to support for a conversation function. The conversation function support application stored in the server memory 240 may be provided to and installed in the user terminal 100 at a request of the user terminal 100. In addition, the server memory 240 may store a word DB related to the conversation function support. The word DB may be used as a resource required to generate the response information to be provided based on the user utterance information and the external information. The word DB may store the degrees of relevance to various words as scores and store a word map in which the degrees of relevance to respective words are classified according to high scores. In addition, the server memory 240 may store a neural network model. The neural network model may select words with the highest selection probability when selecting words contained in the word DB based on the user utterance information and the external information, and then support generating a sentence through an arrangement. Also, the server memory 240 may store user information 241. The user information 241 may include the user utterance information and the external information both received from the user terminal 100. Also, the user information 241 may temporarily or semi-permanently include the response information previously provided to the user terminal 100. The user information 241 may be used as a personalized response information DB for each user terminal 100 and used to construct the word DB by integrating a plurality of user information.

The server processor 260 may receive a user utterance in the form of voice and text and perform preprocessing such as morpheme analysis and tokenization while processing the text as natural language. The server processor 260 may use a preprocessed sentence and the external information (e.g., various kinds of information such as a place, time, weather, etc. where the utterance is being made currently) as an input for generating a sentence. In this case, the server processor 260 may formalize the external information entered into the system through an external API and then use it as an input for sentence generation. In the sentence generation process, the server processor 260 may generate the response information (or response sentence) by applying a specific type of neural network model (e.g., a sequence-to-sequence model) that inputs and outputs a word arrangement. In this regard, the server processor 260 may include a natural language processing module 261, a user interface module 262, a sentence generation module 263, and an external information processing module 264.

The natural language processing module 261 may preprocess the user utterance information received from the user terminal 100. For example, the natural language processing module 261 may generate input information for generating a sentence by performing morpheme analysis, tokenization, etc. on a user utterance. In addition, the natural language processing module 261 may generate a more natural sentence by performing natural language processing on the response information (or sentence) generated by the sentence generation module 263.

The user interface module 262 may provide a designated access screen to the user terminal 100 in response to an access request from the user terminal 100. In this process, the user interface module 262 may establish a communication channel for operating a conversation function with the user terminal 100 based on the server communication circuit 210. The user interface module 262 may perform interfacing to transmit the response information to the user terminal 100 through the server communication circuit 210 and receive the user utterance information and the external information from the user terminal 100.

The external information processing module 264 may process the external information received from the user terminal 100. For example, the external information processing module 264 may collect information such as external temperature, external humidity, external weather, and current location, based on sensing information received from the user terminal 100. For example, the external information processing module 264 may determine, based on the sensing information about the external temperature, whether a current external situation is hot weather or cold weather, and formalize the corresponding external information into hot, cold, etc. In addition, the external information processing module 264 may detect a latitude/longitude value of the current location and obtain a place name or information corresponding to the latitude/longitude value through a map. In a process of extracting a place name or information, the external information processing module 264 may collect formalized information related to city, town, village, etc. or an amusement park, a theme park, an amusement facility, a park, etc. The external information processing module 264 may provide the above formalized information to the sentence generation module 263.

The sentence generation module 263 may perform sentence generation, based on input information corresponding to the user utterance information received from the natural language processing module 261 and the external input information formalized by the external information processing module 264. In this process, the sentence generation module 263 may construct one arrangement of words from the input including the input information generated through the user utterance and the external information, generate words through a neural network model (e.g., model that sequentially generates probabilistically most probable words) designated for the input, and generate the response information by combining the sequentially generated words. As such, in a sentence generation structure of the response information of the present disclosure, the probabilistic calculation value of sentence generation may vary depending on how the external context information is configured for the same user utterance. Therefore, the conversation model can adaptively generate different responses depending on the situation. In addition, because the neural network model of the sentence generation module 263 can learn based on data without the need for an additional design for applying external context information, it is possible to reduce the effort for establishing rules.

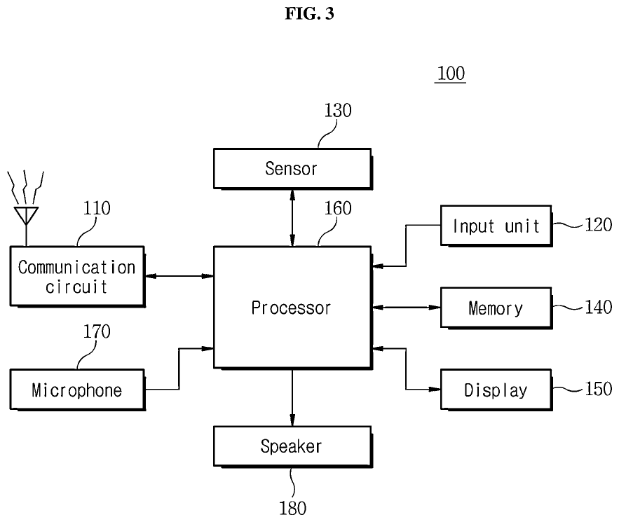

FIG. 3 is a diagram illustrating an exemplary configuration of a user terminal in the configuration of an adaptive conversation system according to an embodiment of the present disclosure.

Referring to FIG. 3, the user terminal 100 according to an embodiment of the present disclosure may include a communication circuit 110, an input unit 120, a sensor 130, a memory 140, an output unit (e.g., at least one of a display 150 and a speaker 180), a microphone 170, and a processor 160.

The communication circuit 110 may establish a communication channel of the user terminal 100. For example, the communication circuit 110 may establish a communication channel with the communication network 50 based on at least one of communication schemes of various generations such as 3G, 4G, and 5G. The communication circuit 110 may establish a communication channel with the conversation support server device 200 under the control of the processor 160 and transmit user utterance information and external information to the conversation support server device 200. The communication circuit 110 may receive response information from the conversation support server device 200 and deliver it to the processor 160.

The input unit 120 may support an input function of the user terminal 100. The input unit 120 may include at least one of a physical key(s), a touch key, a touch screen, and an electronic pen. The input unit 120 may generate an input signal based on a user's manipulation and provide the generated input signal to the processor 160. For example, the input unit 120 may receive a user's request for execution of a conversation function application and provide an input signal corresponding to the user's request to the processor 160.

The sensor 130 may collect at least one kind of external information about the surrounding external situation of the user terminal 100. The sensor 130 may include, for example, at least one of a temperature sensor, a humidity sensor, an illuminance sensor, an image sensor (or camera), a proximity sensor, and a location information acquisition sensor (e.g., global positioning system (GPS)). Sensing information collected by the sensor 130 may be provided as external information to the conversation support server device 200.

The memory 140 may temporarily store a user utterance. Alternatively, the memory 140 may store a model for converting the user utterance into text. The memory 140 may temporarily store text corresponding to the user utterance. The memory 140 may store response information received from the conversation support server device 200 in response to user utterance information and external information. In addition, the memory 140 may store external information (or sensing information) received from the sensor 130 or external information (e.g., web server information, etc.) received from an external server through the communication circuit 110. The memory 140 may store a conversation function application related to the adaptive conversation function support of the present disclosure.

The display 150 may output at least one screen related to the operation of the user terminal 100 of the present disclosure. For example, the display 150 may output a screen related to the execution of the conversation function application. The display 150 may output at least one of a screen corresponding to a state of collecting user utterances, a screen corresponding to a state of collecting external information, a screen indicating transmission of user utterances and external information to the conversation support server device 200, a screen indicating reception of response information from the conversation support server device 200, and a screen displaying the received response information.

The microphone 170 may collect user utterances. In this regard, when the conversation function application is executed, the microphone 170 may be automatically activated. When the conversation function application is terminated, the microphone 170 may be automatically deactivated.

The speaker 180 may output an audio signal corresponding to the response information received from the conversation support server device 200. When the conversation support server device 200 provides an audio signal corresponding to the response information, the speaker 180 may directly output the received audio signal. When the conversation support server device 200 provides text corresponding to the response information, the speaker 180 may output a voice signal converted from the text under the control of the processor 160.

The processor 160 may transmit and process various signals related to the operation of the user terminal 100. For example, the processor 160 may execute a conversation function application in response to a user input and establish a communication channel with the conversation support server device 200. The processor 160 may activate the microphone 170 to collect user utterances, and collect external information by using at least one of the sensor 130 and the communication circuit 110. For example, using the sensor 130, the processor 160 may collect at least one of external humidity, temperature, illuminance, location, and time information. Alternatively, the processor 160 may access a specific server by using the communication circuit 110, and collect external weather and hot issue information from the specific server. The processor 160 may provide the collected user utterance information and external information to the conversation support server device 200 through the communication circuit 110. The processor 160 may receive the response information corresponding to the user utterance information and external information from the conversation support server device 200, and output the received response information through at least one of the display 150 and the speaker 180.

Although it is described above that the user terminal 100 accesses the conversation support server device 200 through the communication network 50, transmits the collected user utterance information and external information to the conversation support server device 200, and receives the corresponding response information, the present disclosure is not limited thereto. In an alternative example, the above-described operations of the adaptive conversation system according to an embodiment of the present disclosure may be all processed in the user terminal 100. Specifically, the processor 160 of the user terminal 100 may execute the conversation function application stored in the memory 140 in response to a user input, and activate the microphone for collecting user utterances. When the conversation function application is executed, the processor 160 may activate the sensor 130 and collect the external information. For example, the processor 160 may collect the external information including at least one of external temperature, external illuminance, current location, and time information. Alternatively, the processor 160 may access a specific server through the communication circuit 110 and collect external weather information, season information, hot issue information, and the like from the specific server as the external information. When the user gives utterance, the processor 160 may collect utterance information and convert the collected utterance information into text. The processor 160 may provide at least a part of the converted text and at least a part of the external information as input information for generating the response information. In this process, the processor 160 may generate the response information by applying user utterance-based input information and external input information formalized from the external information to neural network modeling. The processor 160 may output the generated response information to at least one of the display 150 and the speaker. In this regard, the processor 160 may include a natural language processing module, an external information processing module, a sentence generation module, and a user interface module, and may generate and provide the response information based on the user utterance information and the external information. As described above, the adaptive conversation system of the present disclosure may support to generate and provide the response information suitable for a user's situation only with device components equipped in the user terminal 100.

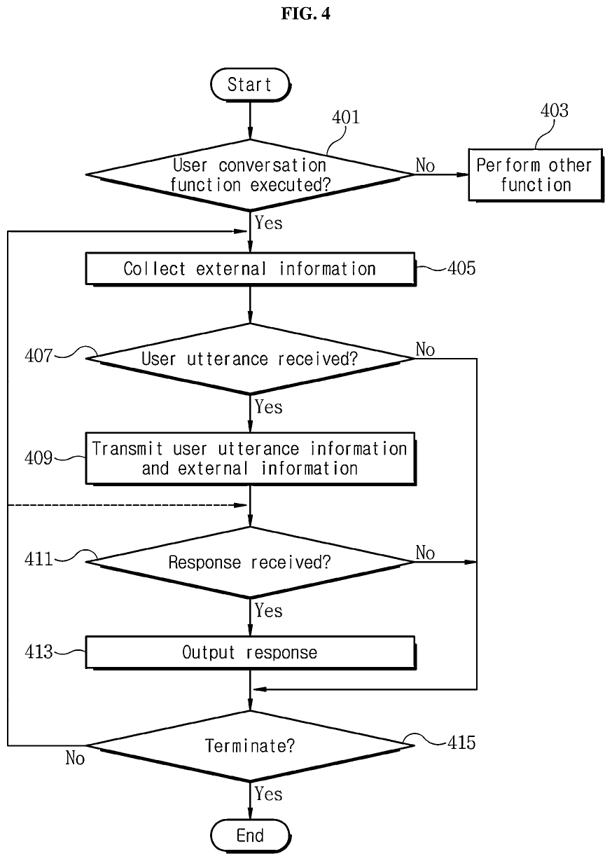

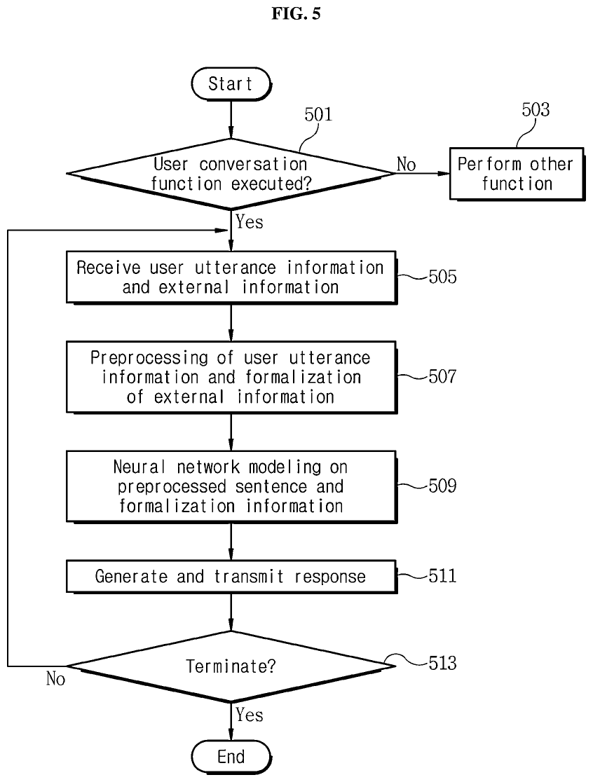

FIG. 4 is a diagram illustrating an exemplary operating method of a user terminal in an operating method of an adaptive conversation system according to an embodiment of the present disclosure.

Referring to FIG. 4, in the operating method of the user terminal 100 for adaptive conversation according to an embodiment of the present disclosure, the processor 160 of the user terminal 100 may determine at step 401 whether a user conversation function is executed. For example, the processor 160 may provide a menu or icon related to the user conversation function and identify whether the provided menu or icon is selected. Alternatively, the user terminal 100 may preset a command related to the execution of the user conversation function and identify whether a voice utterance corresponding to the command is received. When a specific user input is not related to the execution of the user conversation function, the processor 160 may perform other particular function corresponding to the user input at step 403. For example, the processor 160 may provide a camera function, a music playback function, or a web surfing function in response to a user input.

When an input related to the execution of the user conversation function is received, the processor 160 may collect external information at step 405. In this operation, the processor 160 may operate the user terminal 100 to collect user utterance information by activating the microphone 170 upon receiving the input related to the execution of the user conversation function. In addition, the processor 160 may collect the external information around the user by using at least one sensor 130. For example, the processor 160 may collect, as the external information, external temperature, humidity, illuminance, and current location through the at least one sensor. Alternatively, the processor 160 may collect, as the external information, weather information of a current location, a current time, and the like through a web browser. The external information collection may be performed in real time at a request for the execution of the user conversation function or performed at regular intervals.

At step 407, the processor 160 may determine whether a user utterance is received. When the user utterance is received, the processor 160 may transmit the user utterance information and the external information to a designated external electronic device, for example, the conversation support server device 200. In this transmission process, the processor 160 may establish a communication channel with the conversation support server device 200 and transmit unique identification information, user utterance information, and external information of the user terminal 100 through the communication channel.

At step 411, the processor 160 may determine whether a response is received from the conversation support server device 200. When the response is received from the conversation support server device 200 within a specified time, the processor 160 may output the received response at step 413. In this process, the processor 160 may output the response through the speaker 180. Alternatively, the processor 160 may output text corresponding to the response on the display 150 while outputting the response through the speaker 180.

At step 415, the processor 160 may determine whether an input signal related to termination of the user conversation function is received. When the input signal related to the termination of the user conversation function occurs, the processor 160 may terminate the user conversation function. In this operation, the processor 160 may deactivate the microphone 170 and release the communication channel with the conversation support server device 200. In addition, the processor 160 may output guide text or guide audio related to the termination of the user conversation function. If there is no input related to the termination of the user conversation function, the processor 160 may return to the previous step 405 of collecting the external information and then wait for reception of the user utterance. Alternatively, the processor 160 may return to the previous step of waiting for reception of the response after transmitting the user utterance information and the external information. In this case, if the response is not received for a given time, the processor 160 may output an error message indicating a response reception failure and proceed to the step 415. In addition, if the user utterance is not received for a given time at the step 407, the processor may proceed to the step 415 to determine whether an event related to the termination of the user conversation function (e.g., an event that automatically requests the termination of the conversation function when there is no user utterance for a given time, or a user input event related to the termination of the conversation function) occurs. Also, if there is no response for a given time at the step 411, the processor 160 may skip the step 413 and perform the subsequent step.

FIG. 5 is a diagram illustrating an exemplary operating method of a conversation support server device in an operating method of an adaptive conversation system according to an embodiment of the present disclosure.

Referring to FIG. 5, in the operating method of the conversation support server device related to adaptive conversation function support according to an embodiment of the present disclosure, the server processor 260 of the conversation support server device 200 may determine at step 501 whether a user conversation function is executed. For example, the server processor 260 may determine whether a message of requesting the establishment of a communication channel related to the use of the user conversation function is received from the user terminal 100. Alternatively, the server processor 260 may determine whether a time for executing the user conversation function with the user terminal 100 has arrived according to scheduling information or settings. When the scheduled or set time arrives, the server processor 260 may establish a communication channel with the user terminal 100 in order to execute the user conversation function. If an event related to the execution of the user conversation function does not occur at the step 501, the server processor 260 may perform other particular function at step 503. For example, the server processor 260 may update a neural network model, based on responses provided to previous user utterances and external information. Updating the neural network model may be performed in real time in the process of supporting the conversation function with the user terminal 100. In another example, the server processor 260 may update a word DB by collecting new words and information defining the meaning of words from other portal servers or news servers. Words contained in the word DB may be used to generate a response.

When the communication channel is established with the user terminal 100 for executing the user conversation function, the server processor 260 may receive user utterance information and external information from the user terminal 100 at step 505. When there is no reception of user utterance information and external information for a given time, the server processor 260 may release the communication channel with the user terminal 100 and terminate the user conversation function.

At step 507, the server processor 260 may perform preprocessing of the user utterance information and formalization of the external information. In relation to the preprocessing of the user utterance information, the server processor 260 may convert the user utterance into text and then rearrange sentences contained in the text in units of words. The server processor 260 may perform morpheme analysis and tokenization on the rearranged words and thereby generate input information to be used for generating a sentence. Also, the server processor 260 may select at least one external information as input information to be used for generating a sentence. In this process, the server processor 260 may detect, from the word DB, a word highly related to the input information generated based on the user utterance from among the external information. In this regard, the word DB may store a map in which the degrees of relevance of respective words are recorded.

At step 509, the server processor 260 may perform a neural network modeling on the preprocessed sentence and formalization information. That is, the server processor 260 may apply input information (e.g., input information acquired through a user utterance and external input information acquired from external information) to a specific neural network model (e.g., a sequence-to-sequence model). Here, the input information through the user utterance and the external input information may be configured as one arrangement of words and provided as an input for generating a sentence. The neural network model is not limited to the exemplified model and may sequentially generate words with the highest probability.

At step 511, the server processor 260 may generate response information based on the neural network modeling and transmit the generated response information to the user terminal 100. In this process, the server processor 260 may perform post-processing, such as natural language processing, on the response information generated through the neural network modeling.

Next, at step 513, the server processor 260 may determine whether an event related to termination of the user conversation function occurs. When there is no event related to the termination of the user conversation function, the server processor 260 may return to the previous step 505 and perform again the subsequent operations. When an event related to the termination of the user conversation function occurs, the server processor 260 may terminate the user conversation function. For example, the server processor 260 may release the communication channel with the user terminal 100 and transmit a message indicating the termination of the user conversation function to the user terminal 100.

As described hereinbefore, the adaptive conversation system 10 according to an embodiment of the present disclosure and the operating method thereof can provide the conversation model capable of interacting with the user by utilizing the external context information of the user who uses the conversation function, thereby supporting adaptive conversation that allows various utterance configurations depending on the external information. In addition, the present disclosure proposes a technique capable of utilizing data-based external information by using the neural network model.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A conversation support server device comprising:
a server communication circuit configured to establish a communication channel with a user terminal; and
a server processor functionally connected to the server communication circuit, the server processor configured to:
receive, from the user terminal, a user utterance and external information including location information where the user utterance is made, time information, weather information, and hot issue information;
construct one arrangement of words by combining input information generated by performing natural language processing on the user utterance with the external information;
generate a response sentence by applying the word arrangement to a predetermined neural network model; and
transmit the response sentence to the user terminal,
the server processor further configured to detect a place name or place characteristic information corresponding to the location information through map information mapped to the location information.

2. The conversation support server device of claim 1, wherein the server processor is configured to produce formalized information corresponding to the external information, and then generate the one arrangement of words by combining the formalized information with the input information.

3. The conversation support server device of claim 1, wherein the server processor is configured to receive sensing information of a sensor included in the user terminal as the external information, and produce formalized information corresponding to the sensing information.
